(19) United States
(12) Patent Application Publication
(10) Pub. No.: US 2024/0046050 A1
(43) Pub. Date: Feb. 8, 2024

(54) WIDE AREA RFID TARGET ACQUISITION AND LOCATION SYSTEM FOR PROGRAMMING RFID DEVICES

(71) Applicant: RF Controls LLC, St. Louis, MO (US)

(72) Inventors: Graham P. Bloy, St. Louis, MO (US); Alex J. Gaddie, St. Peters, MO (US); Eric W. Feiste, Kirkwood, MO (US)

(21) Appl. No.: 18/230,070

(22) Filed: Aug. 3, 2023

Related U.S. Application Data
(60) Provisional application No. 63/394,825, filed on Aug. 3, 2022.

(51) Int. Cl. G06K 7/10

(52) U.S. Cl. CPC G06K 7/10198

(57) ABSTRACT

Systems and methods allowing for RFID tags to be programmed from a distance and in a situation where multiple RFID tags may be within range of a programming reader such as when they have been previously attached to a good and the good is already in an RFID monitored system. The programming reader typically utilizes a steerable phased array antenna to first identify and then target a specific tag before sending instructions to program the tag.

### CROSS-REFERENCE TO RELATED APPLICATIONS

This application claims the benefit of U.S. Provisional Pat. App. No. 63/394,825, filed Aug. 3, 2022, the entire disclose of which is herein incorporated by reference.

### BACKGROUND OF THE INVENTION

### Field of the Invention

This disclosure is related to wide area RFID target acquisition and location systems and specifically for programming RFID devices at a distance utilizing a bidirectional electronically steerable phased array antenna and associated control system.

### Description of the Related Art

Staying organized is an ongoing task for both individuals and businesses although the concept of organization is really quite simple. Being organized often simply boils down to knowing what you have and where it is. Keeping organized, thus, involves needing two pieces of information. First, you need to identify something you have and the second is connecting that thing to the location where it is.

The simplest way to stay organized, and what is done in many cases, is to simply have a fixed location where a known thing is. Thus, so long as you know you have the thing, you know where it is. The difficulty is, however, in maintaining these two pieces of information for everything as well as accurately updating the information when things are added and removed. Everyone has misplaced something because it did not get returned to where it was supposed to be or realized we had something we had forgotten about when a location not commonly looked at was searched.

Humans have trouble staying organized because we simply don't have accurate enough memory to maintain these two pieces of information on everything we care about, much less having the capacity to update our memory when things change. In large businesses, this problem is exaggerated because the sheer volume of things whose location is important is increased immensely. Because of our inability to remember everything and accurately update, we have long tried to store the information in inventory logs. Records of logs exist in human culture for thousands of years in both written and other forms. With the advent of digital memory and digital computing, however, the ability to generate and maintain logs became vastly more powerful and more accessible. Specifically, computer memory allowed storage of dramatically increased amounts of data with reduced amounts of the information being lost. However, it was rapidly discovered that the ability to update and use a computerized log was often still well beyond our human capacity.

To deal with the problem of updating, it was recognized that having the machines storing the log information be able to update themselves on changes to the location of the things would be immensely helpful. In this way, the machine would not only remember the initial inventory data, but be able to update it so it stayed accurate over time. This would eliminate the need for a human to update the log, which was becoming increasingly problematic as the logs got more complicated. The problem was how to get the computer and things to communicate with each other without the human in the middle to interpret.

The concept of having a thing communicate with a computer directly is often termed “Internet-of-things” or “IoT.” The basic premise of IoT was that with the advent of computer networking (computers communicating directly with other computers digitally) if everything could effectively be made to communicate digitally, computer systems could update information without a human having to do it. Within the concept of organization, this meant that a thing could identify itself to a computer and tell the computer where it was. This would allow the computer to store the information and it could be later retrieved by a human who would quickly know where the thing was and find it. Effectively, if things can identify themselves to a computer, the computer can track them without human intervention.

The problem is that non-digital things and computers cannot readily communicate. The solution was to attach a digital communication tag to such a non-digital thing where such automatic updating was desired. This is typically thought of as some kind of tracking tag and is often generally called a proxy. The proxy acts to provides the necessary communication to the computer and provides information about itself and, thus, about the thing it is attached to.

We are all familiar with the proxy concept as many of us use it every day. Smartphones that give directions do not actually know where the smartphone user is when they provide directions, instead, the directions are how to move the phone. Because the user is carrying the phone, the directions work because the phone provides a proxy for the user. The proxy concept is, in fact, pervasive in the modern world. Locations of mobile devices, such as smartphones, are regularly used as proxies for their owners' (who they are associated with and “identify”) locations. Further, actions taken by a car (such as running a red light) are often assigned to actions of the car's owner. These are all examples of proxies.

The problem with many IoT applications of the proxy technology is that the proxy was too big, too complicated, or too expensive to use with the thing whose tracking was needed. To accurately track things, everything to be tracked has to be connected (usually physically) to a specific proxy that can communicate necessary information. To deal with the problem of cost and complexity, in many IoT applications, the proxies need to be simplified and made less expensive while still providing all the necessary pieces of information. One solution to this is Radio-Frequency Identification (RFID) systems.

In simple terms, an RFID system simply places a small device called a “tag” on everything which is to be tracked. The tag includes an antenna which can communicate with a reader via radio frequency communication. The tag is most commonly passive and acts to provide only limited information (effectively an identification) only when queried for that information by a more complicated device called a reader. The reader then takes the provided information and in conjunction with a computer processor or other control system, uses the responded information to provide data on the thing to which the RFID tag is connected.

Most RFID tags cannot actually provide location information. Technology to put that capability in the RFID tag is currently too expensive. Instead, to determine where the tagged thing is, a limitation on radio frequency communication is used as a feature. Bidirectional radio frequency communication can only occur under certain circumstances. Specifically, the communication requires antennas to be correctly aligned and sufficiently close. The position indication, therefore, has typically used proximity, and the nature of electronic communication being directionally and dimensionally limited, to specify that any tag that can successfully respond to an inquiry from a reader, must be within the known proximity and known dimensional positon relative to the reader to enable bidirectional communication. Because the specifics of the range and dimensions can then be altered based on antenna design in the reader and tag, the possible locations where a tag can successfully respond to a reader can be limited based on where the reader is placed and how it operates.

Modifying the areas where a reader can read from, and adding more readers, then allows for more granularity in where a responding tag is. For example, certain readers are mounted in a specific area, for example in a shelving unit, and have only a very short range. In this case, they can only interrogate and receive information from tags that are in very close proximity (e.g. on the shelf). Because of this limitation, any tag that responds is connected to a thing on the shelf and if the tag identifies a thing attached, that thing is on the shelf. In this way, the location of any thing whose tag responds is quite specifically known.

However, setting up readers with very limited range can get very expensive due to the number of readers required. As an alternative, one can simply allow for a reader with broader coverage to act as multiple different readers with a variety of different coverages by altering the way the reader works when the inquiry is sent. In this case, the mode of inquiry to which a tag responds, or does not respond, will provide increased granularity on the tag's specific location. Further, certain kinds of readers often work in concert under the same control system to allow for different levels of granularity as required.

It should be apparent that for RFID systems to be used, effectively every thing to be tracked has to have an RFID tag and each tag needs to be able to uniquely identity the good it is attached to. Tags, therefore, typically need to be programmed to be able to respond in a fashion that allows them to identify what they are attached to. Tags can always just identify themselves, but then somewhere else there needs to be a lookup table or similar to connect the tag identifier to the attached thing. It is better if the tag can directly identify the tagged thing. To allow for standardization of RFID communication and how to do this identification, there are standards and many RFID tags and readers contemplated herein will typically utilize the RAdio frequency IdentificatioN (RAIN) standard GS1 UHF Gen2 protocol (ISO/IEC 18000-63).

An RFID tag, using this protocol, will typically include at least two pieces of information. The transponder ID (TID) is typically programmed into an RFID tag when the tag is manufactured and is a unique identifier which identifies the tag itself. A TID is typically read-only and unalterable as it identifies the specific microchip in the tag. As such, it provides no information about the thing which is tagged by the tag, but it may be connected to a certain thing via a lookup table or the like. However, while the TID is readable by most RFID readers, it is generally not used in locating attached things because it requires a substantial lookup table to connect with a good and this is not usually feasible. However, the TID always will identify a specific tag.

To provide information about the associated good, a second serial number is usually programmed into an RFID tag. This is referred to as an Electronic Product Code (EPC). The EPC is written to a passive RFID tag by the product's manufacturer or other entity that wants the tag to identify the good it is attached to and its form is usually controlled by standard and protocol to allow for any thing using a tag with the same protocol to be accurately identified without the need for a large lookup table. As such, the EPC will typically contain a company identifier, a product identifier and a unique serial number in the format of the protocol the tag uses. In most cases, companies using RFID tags will read the EPC numbers since they want the information on the good that the tag is attached to, not the tag itself.

Based on all this, the EPC data allows for creation of a human readable log of anything that is within range of the antennas of the control system so long as those things have a tag using a protocol recognized by a reader associated with that control system. Further, specifics of the communication with the readers in this control system allow for location data to be determined for all those things to a granularity selected by the user of the control system. Further, as those things move, changes in the way they interact with the readers allows for the log to be automatically updated. Thus, a fully automated tracking system is implemented.

Because the EPC is specific to the attached thing, however, tags need to be programmed with that information to make sure that they correctly identify the attached thing. EPC programming has traditionally been done by specialized readers that are typically handheld and require close proximity with the tag for the write operation to take place. The reason for close proximity is because the signal writing and EPC to one tag cannot be received by another tag or else that tag could potentially also be rewritten. The signal also needs to be sufficiently strong form the write operation to take place. This meant that the most efficient way to “program” tags for use was to program them before they were attached to goods. RFID tags are currently assigned EPC values by a stationary EPC printer, where the tag is programmed while inside the printer. Only after being assigned an EPC number by the printer is it attached to the object to track.

While this works just fine in many situations, it imposes some limitations. Specifically, the goods to be tagged need to be known and identifiable before the tags can be prepared. It also requires that the tags not be placed on the goods before they are programmed and typically also requires tags to be simply thrown out if the good is consumed and they cannot be reused or altered. This can result in inefficiencies in tagging. For example, tags cannot be altered if the underlying thing is altered as a new tag has to be generated and the existing one replaced to indicate the alteration has taken place.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems and methods allowing for RFID tags to be programmed from a distance and in a situation where multiple RFID tags may be within range of a programming reader such as when they have been previously attached to a good and the good is already in an RFID monitored system. The programming reader typically utilizes a steerable phased array antenna to first identify and then target a specific tag before sending instructions to program the tag.

In an embodiment, there is disclosed a system and method for programing of an RFID tag at a distance, the system comprising: providing a control system including a reader, the reader being in communication with a field of RFID tags; selecting a target tag in said field of tags for a write operation, said target tag having a TID identifying the target tag; locating said target tag in said field of tags; said reader modifying its communication to improve communication with said target tag over other tags in said field of tags; said reader using said modified communication to send a write operation to said target tag; verifying said target tag carried out said write operation using said TID of said target tag.

In an embodiment of the method the distance comprises at least 15 meters.

In an embodiment of the method the target tag is selected when it enters said field of tags.

In an embodiment of the method the TID is used by said reader to select said target tag.

In an embodiment of the method the write operation writes an EPC to said target tag.

In an embodiment of the method the target tag includes an existing EPC and said write operation will modify said existing EPC.

In an embodiment of the method the target tag includes an existing EPC and said write operation will overwrite said existing EPC.

In an embodiment of the method the target tag includes an existing EPC and said selecting is based on said existing EPC.

In an embodiment of the method the write command is a kill command.

In an embodiment of the method the modifying its communication comprises steering a steerable phased array antenna in said reader to said target tag.

In an embodiment of the method the modifying its communication comprises using spread spectrum frequency analysis to determine a best frequency at which said target tag resonates

In an embodiment of the method the modifying its communication comprises determining a best RF to communicate with said target tag.

In an embodiment of the method the modifying its communication comprises determining a best power level to communicate with said target tag.

In an embodiment of the method the target tag is one of a plurality of tags simultaneously sent said write command.

### BRIEF DESCRIPTION OF THE DRAWINGS

FIG. 1 provides an image showing a target tag which is to be programmed in a field of tags

FIG. 2 provides an image of a process flowchart of an embodiment of the present method.

FIG. 3 provides an image of a flowchart of the operation of a computer control of an embodiment of the present system.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Throughout this disclosure the term “computer” means hardware which generally implements functionality provided by digital computing technology, particularly computing functionality associated with microprocessors. The term “computer” is not intended to be limited to any specific type of computing device, but it is intended (unless otherwise qualified) to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including, but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service (SAAS), or other distributed or collaborative computer networks. Thus, to the extent this disclosure describes systems or methods as being performed by or on a computer, a person of ordinary skill in the art will understand that, unless specified otherwise, the systems and methods may be implemented on a single device or distributed across multiple devices.

Those of ordinary skill in the art also appreciate that some devices not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to: network hardware, print servers, file servers, NAS and SAN, load balancers, IoT devices, smart devices, and other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including, without limitation, virtual processors, or by the use of run-time environments, virtual machines, and/or interpreters.

Those of ordinary skill in the art recognize that although software is traditionally stored in a non-transitory computer-readable medium and loaded into memory on demand for execution, software can also be wired or embedded into hardware, including, without limitation, onto a microchip, and still be considered “software” within the meaning of this disclosure. For purposes of this disclosure, software includes, without limitation: instructions stored or storable in hard drives, RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including, but not necessarily limited to, a network socket connection. Those having ordinary skill in the art will further appreciate that a “server” may comprise a plurality of software and/or hardware servers delivering a service or set of services as described elsewhere herein. Those having ordinary skill in the art will further appreciate that the term “host” may, in noun form, refer to an endpoint of a network communication or network (e.g., “a remote host”), or may, in verb form, refer to a server providing a service over a network (“host a website”), or an access point for a service over a network.

Throughout this disclosure, the term “real-time” refers to software operating within short enough operational deadlines for a given event to commence or complete, or for a given module, software, or system to respond, that the responsiveness of the system is, in ordinary user perception within the technological context, effectively cotemporaneous with a reference event. For example, when the user clicks on an interface element, the system exhibits some kind of response that indicates that click was received and is being, or already has been, processed and acted upon. Those of ordinary skill in the art understand that “real-time” does not literally mean the system processes input and/or responds instantaneously, but rather that the system processes and/or responds rapidly enough that the processing or response time is within the general human perception of the passage of real-time in the operational context of the program. Those of ordinary skill in the art understand that, where the operational context is a local graphical user interface, “real-time” normally implies a response time of no more than one second of actual time, with milliseconds or microseconds being preferable. However, those of ordinary skill in the art also understand that, under other operational contexts, a system operating in “real-time” may exhibit delays longer than one second, particularly where network operations are involved.

Programming of RFID tags will utilize typical RFID readers such as those manufactured by RF Controls as the RFC 400 Series product line which are connected to a common operating system. In most cases, the readers will be connected as a part of a computer network to a central processor which controls their operation and the readers will communicate and be controlled by that central processor. As the specific layout and structure of this arrangement is highly variable, it is referred to herein as a “control system” where the control system acts to control the operation of the readers.

Typically readers and the control system will utilize firmware and software on an associated computer readable medium to achieve the functionality of writing contemplated herein. However, the readers and control system may include hardware that carries out any or all the steps of the methods herein in an alternative embodiment. The readers will include radio frequency antennas in the form of bidirectional steerable arrays. The RFID tags to be programmed will typically be passive tags operating in accordance with the GS1 UHF Gen2 protocol. Decisions to program (issue a write or other command) can be fully automated and/or selected by manual input. In an embodiment, the system is designed to operate in, but is not limited to, the 900 megahertz and 2.4 gigahertz band.

While some RFID reader devices can already program RFID tags, it should be recognized that they can only do so at close distances and usually only with a singular target in their range. For example, a handheld reader can program a single tag it is placed within a few inches of, as there is no signal received by any other RFID tag and the write command is correctly received with sufficient strength to be carried out. This, however, requires human intervention to write tags. Specifically, either the tag must be brought to a specialized reader, or a specialized reader brought to a tag, to carry out a write operation.

The present systems and methods allow for RFID tag programming at distances previously not possible. This systems and methods do this using target acquisition and location technology to pinpoint a specific tag, in a field of tags, and has a programming range in excess of 15 meters, although no specific distance of travel is actually required and distances both under and over that may be used. Alternatively, a reader can target a moving tag which has come into range and then lock onto the tag allowing it to be altered even as the target is moving.

The process of writing tags in accordance with the present systems and methods utilizes a reader with steerable phased array antennas such as but not limited to, those contemplated in U.S. Pat. No. 8,599,024, the entire disclosure of which is herein incorporated by reference. The present systems and methods are used to set, delete, or alter an EPC in an RFID tag which is within a field of RFID tags. In an embodiment, if the tags support user memory which allows for storage of other programmable information in addition to an EPC, the contents of that memory also can be modified at those distances to support a user's application. Further, at the end of a tag's use, they often need to be disabled which can also be done by use of a kill command programmed to the tag also from these aforesaid distances.

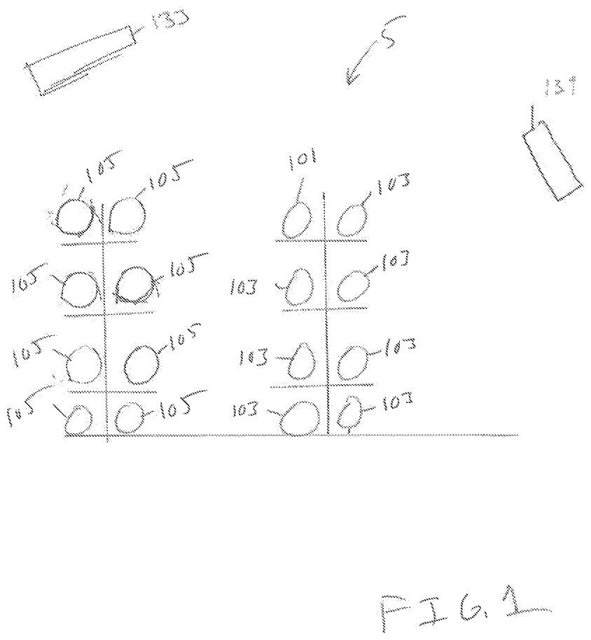

In the present disclosure, a target tag (101) to be written will typically be within a field of tags (5) such as in FIG. 1. In a field of tags (5) an RFID reader (131) and (133) can communicate with any of a multiple of tags (101), (1030), and (105) and will typically do inventory by communicating with all of them. At the instant that the programming is to occur, however, the RFID reader (131) or (133) is setup to only communicate with a single one of the tags in the field and to maximize the range and effectiveness of the communication. In an embodiment, the system utilizes the TID of the tag to assist in singling it out while also using various targeting methodologies of the reader to make sure that the write command is sent to the target tag (101). In this way, when the programming occurs, only that target tag (101) is programmed.

FIG. 1 provides an embodiment showing the concept of a field of tags (5) where a particular target tag (101) is surrounded by other tags (103) and (105) which can all communicate with readers (131) and (133). However, in a first embodiment, only tag (101) is to be altered in its programming. In the field of tags (5), some tags (103) and (101) are best communicated with by one reader (131) while other tags (105) are best communicated with by another reader (133) based on their current location. However, for purposes of improving the explanation, in the field of tags (5) any reader (131) and (133) could communicate with any tag (101), (103), and (105).

Alternatively, once a target tag (101) is selected, a reader (131) will seek that specific tag as tags (101), (103), and (105) pass within range of the reader (131). This may occur, for example, as forklifts move the thing carrying the target tag (101) into or out of the antenna's (131) monitored zone. Once the target tag (101) is located, the antenna (131) can lock onto the target tag (101) so as to follow it as it moves and program it without need for it to stop moving or to be supplied to a particular writing area or system.

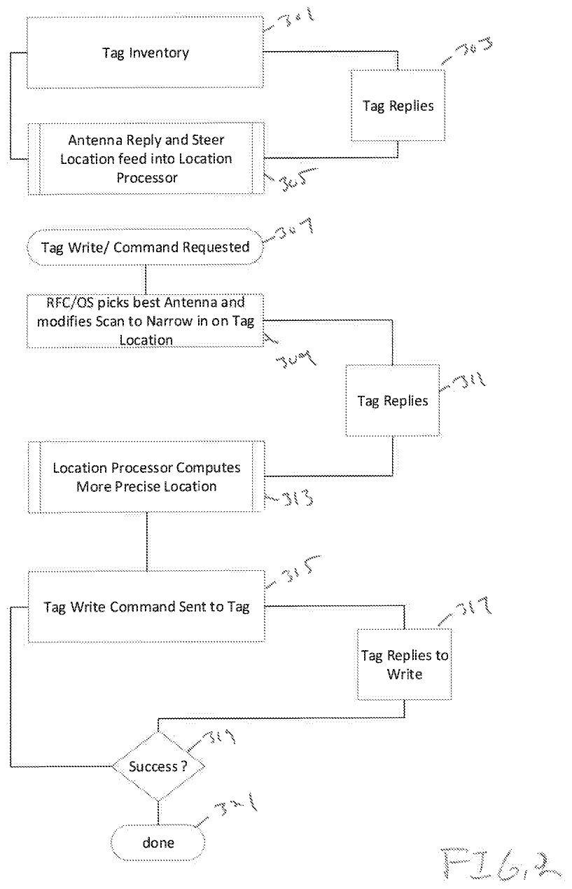

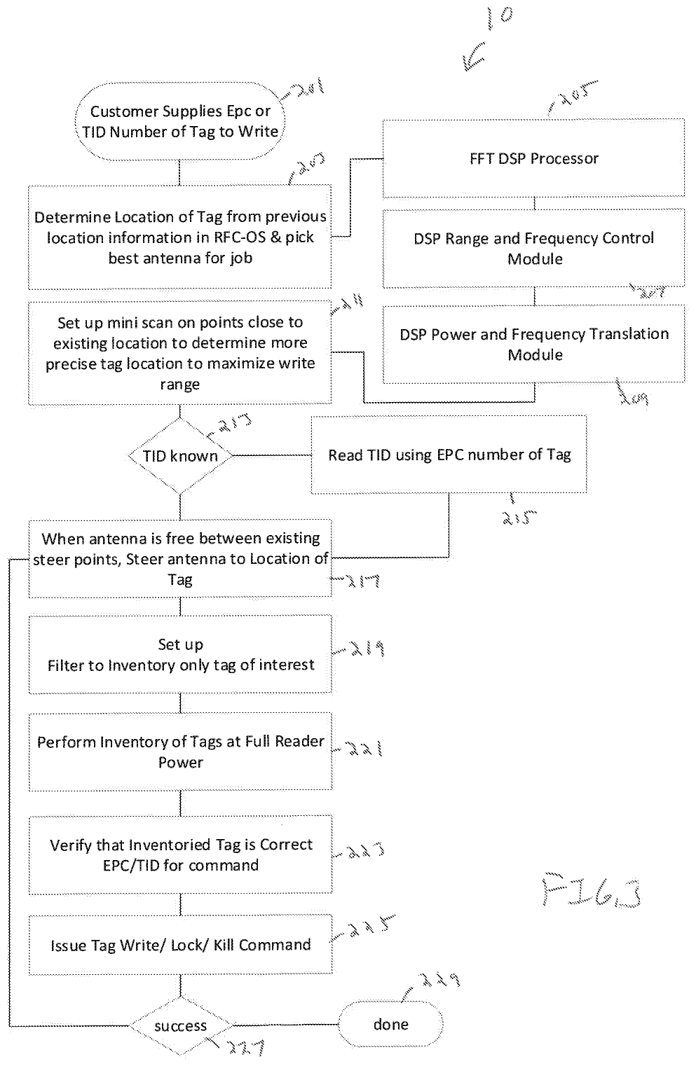

FIG. 2 provides for a flowchart of an embodiment of how targeting and writing can occur. The target tag (101) will be identified to a control system (10) whose operation is discussed in more detail in conjunction with FIG. 3. In step (201), the target tag (101) which is to be programmed with a new EPC, is originally identified. The target tag (101) may be identified by the TID associated with that specific target tag (101), by an old or placeholder (e.g. default) EPC which is currently known to be on the target tag (101), or by the combination of both. Typically, what is chosen is based on the purpose of a write operation. For example, a new unused tag will often be identified by a TID, while a tag for a specific thing that needs the identity of the thing changed may be targeted by EPC.

The target tag (101) is identified to the control system typically because the EPC is to be rewritten and a user has identified the target tag (101) to be so rewritten. The target tag (101) may need to be rewritten because it needs to provided with an initial value, for example because it has now been attached to a specific good, which was not identified at the time the target tag (101) was attached but now is attached. Alternatively, the target tag (101) may be being reused and is now attached to a good it was not previously attached to and it current identifies the old good, or the EPC is to be written in a fashion to indicate that the target tag (101) is out of service and should be disposed of or not used. This latter option may also be used to avoid disclosure of EPC information in disposed of tags or to perform a kill operation to destroy the target tag (101).

Once the target tag (101) is identified to the control system (10), it typically needs to be located as being within the field of tags (5) and it's specific location within the field of tags (5) needs to be determined. This location is typically done in a stage process which provides for increasingly close focus on the target tag (101). First, the general location of the target tag (101) is determined. Specifically, the target tag (101) should be in a tag inventory (a record of all tags known) by the control system (10). This is typically done by reviewing current information on where the target tag (101) is based on the inventory (203) in the control system (10).

This basic location may also result in the control system (10) running a simple inquiry (e.g. an inventory) of everything it can communicate with to make sure that the target tag (101) responds (303) at all. Once completed, this step has verified that the target tag (101) is actually in the field of tags (5) of FIG. 1. This is performed using standard RFID inventory control systems and methods. The control system (10) will then typically switch over to write control operations (307). In an alternative embodiment, the tag is identified when it enters the area of inquiry of the antenna (131). For example, it may be know that the target tag (101) should be being moved from one room to another. The reader (131) in this case may be the reader monitoring the doorway between those two rooms which will search for the target tag (101) to enter its target area.

Once the target tag (101) has been acquired within the general region, processing via dynamic statistical algorithms and other systems will define and select (203) and (309) the best operational antenna (131) or (133) to write to the target tag (101). In this case, antenna in reader (131) is the best as previously indicated in conjunction with FIG. 1. With the target tag (101) correctly identified and the antenna (131) selected, the antenna (131) will now typically be configured to maximize communication effectiveness (205), (207), (209) with that target tag (101) and narrow the location (309) of the target tag (101) so that communication becomes stronger with the target tag (101). This helps improve the write operation range and effectiveness. Further, it can allow the reader (131) to connect with the target tag (101) and stay connected to it even as the target tag (101) moves.

This maximization of communication may be done using a variety of techniques and typically by continuing to interrogate the target tag (101) and making sure it replies (311). In an embodiment, the control system (10) will clear the inventory of known tags (219) leaving only the target tag (101). The system will then make sure that the full inventory (which is just the target tag (101)) will respond and use continued inquiry/response to better maximize its operation for communication with the target tag (101) based on the ongoing communication. The control system (10) in this embodiment can be only communicating to tags in inventory (221) which will only be the target tag (101). Limiting the inventory this way can also be used if multiple target tags (101) are to be targeted at once.

Depending on embodiment, the specific systems and methods used in the process of maximization can include, but are not limited to, using spread spectrum frequency analysis (FFT) the best frequency at which the RFID tag resonates is chosen. In tandem, the proper RF polarity may be selected. In an embodiment, the systems and methods described in RF Controls U.S. Pat. No. 8,698,575, the entire disclosure of which is herein incorporated by reference, are used for polarity switching functionality within the antenna control system. Using data from systems and methods such as, but not limited to, the RF Controls patented phase ranging algorithms described in U.S. Pat. No. 8,344,858, the entire disclosure of which is herein incorporated by reference, the system may also or alternatively be directed to select the proper power level to write the tag.

Once the antenna (131) is selected and its communication effectiveness maximized with the target tag (101) whose location has been specifically defined and targeted, the target tag (101) is typically verified (223) prior to writing. As indicated above, the target tag (101) will often be located using an existing (but now inaccurate) EPC on the target tag (101) and, in an embodiment, that EPC interrogation will be used throughout the targeting and communication maximization. To make sure that the target tag (101) is that actually now narrowly targeted, if the TID of the tag is known (213), the tag may be interrogated by the antenna for the TID and this may be used to verify that indeed the located and targeted tag is the target tag (101). If the TID is not known, the target tag (101) will typically be inquired for its TID to use in the write command and later verification of a successful write command. Regardless of what was used to locate the target tag (101), in an embodiment, the TID may be used to insure that the write instruction is only received by the target tag (101).

The control system has now aligned (217) the antenna (131) using the proper steer angle so the antenna is culminated on the target tag (101) to be written (305). At this stage, the receiver has effectively singled out the target tag (101) from the field of tags (5) and is aimed specifically at it and maximized itself for communication with that target tag (101) as best as possible. With the target tag (101) now identified and targeted and the operation of the antenna (131) maximized for communication with the target tag (103) over all other tags (103) and (105) in the field of tags (5), the control system (10) will begin the process of writing. Using the TID of the tag, the new EPC or user data is then written (225) by sending a write command (315) using all of the RF information previously gathered from the target tag (101). The target tag (101) should respond (317) to the write command and the new EPC as written is then validated against the TID (227) at the control system (10) to verify the write process was successful. If an error is discovered in the newly written tag data the entire process may be retried with the current EPC/TID combination which was not successfully rewritten. Alternatively, if the write is deemed a success and the process is complete (229). At completion, the control system (10) will return the antenna (131) to its normal operation.

While the above discussion contemplates the targeting of a single target tag (101), it should be recognized that multiple tags may be targeted instead. In an alternative embodiment, tags (103) are the target tags and the antenna (131) communicates with all these tags (103) at once. In this embodiment the EPC numbers for a large group of tags, for example, those of a specific prior value, could have a new and identical EPC written to them.

By using an electronically steerable phased array antenna in conjunction with an appropriate control system (10), tags can be attached to their objects even if the EPC number has not yet been assigned. Further, the ability to write and rewrite in place tags that are within a field of tags (5) allows for increased use of RFID tags particularly on reusable structures which are used at different times to carry different things. As an example, once a reusable tote has been emptied, the RFID tag on the tote could be changed to indicate that it was now empty. Further, once refilled the tag could again be reprogrammed to identify the new contents. Further, the ability to alter tags can also be used to allow for parts that are modified over time, such as in a manufacturing process, to have tags altered instead of the tags needing to be replaced.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method for programing of an RFID tag at a distance, the system comprising:
providing a control system including a reader, the reader being in communication with a field of RFID tags;
selecting a target tag in said field of tags for a write operation, said target tag having a TID identifying the target tag;
locating said target tag in said field of tags;
said reader modifying its communication to improve communication with said target tag over other tags in said field of tags;
said reader using said modified communication to send a write operation to said target tag;
verifying said target tag carried out said write operation using said TID of said target tag.

2. The method of claim 1, wherein said distance comprises at least 15 meters.

3. The method of claim 1, wherein said target tag is selected when it enters said field of tags.

4. The method of claim 1, wherein said TID is used by said reader to select said target tag.

5. The method of claim 1, wherein said write operation writes an EPC to said target tag.

6. The method of claim 1, wherein said target tag includes an existing EPC and said write operation will modify said existing EPC.

7. The method of claim 1, wherein said target tag includes an existing EPC and said write operation will overwrite said existing EPC.

8. The method of claim 1, wherein said target tag includes an existing EPC and said selecting is based on said existing EPC.

9. The method of claim 1, wherein said write command is a kill command.

10. The method of claim 1, wherein said modifying its communication comprises steering a steerable phased array antenna in said reader to said target tag.

11. The method of claim 1, wherein said modifying its communication comprises using spread spectrum frequency analysis to determine a best frequency at which said target tag resonates

12. The method of claim 1, wherein said modifying its communication comprises determining a best RF to communicate with said target tag.

13. The method of claim 1, wherein said modifying its communication comprises determining a best power level to communicate with said target tag.

14. The method of claim 1, wherein said target tag is one of a plurality of tags simultaneously sent said write command.
